(19) United States
(12) Patent Application Publication
(10) Pub. No.: US 2026/0017303 A1
(43) Pub. Date: Jan. 15, 2026

(54) RESOURCE SCREENING METHOD AND APPARATUS, COMPUTER DEVICE, AND STORAGE MEDIUM

(71) Applicant: TENCENT TECHNOLOGY (SHENZHEN) COMPANY LIMITED, Shenzhen (CN)

(72) Inventors: Shuyi XIE, Shenzhen (CN); Donglin ZHOU, Shenzhen (CN); Yuequn LI, Shenzhen (CN); Zhichao HU, Shenzhen (CN)

(73) Assignee: TENCENT TECHNOLOGY (SHENZHEN) COMPANY LIMITED, Shenzhen (CN)

(21) Appl. No.: 19/335,231

(22) Filed: Sep. 22, 2025

Related U.S. Application Data
(63) Continuation of application No. PCT/CN2024/115110, filed on Aug. 28, 2024.

(30) Foreign Application Priority Data
Sep. 21, 2023 (CN) 202311220326.0

(51) Int. Cl. G06F 16/335; G06F 16/3329

(52) U.S. Cl. CPC G06F 16/335; G06F 16/3329

(57) ABSTRACT

A resource screening method includes obtaining historical behavior information of an object and model indication information, the historical behavior information indicating that the object has interacted with a resource, the model indication information indicating that a large language model generates interest description information based on input information, and the interest description information describing a resource of interest to the object; prompt information indicating a resource with which the object has interacted is generated based on the historical behavior information; the interest description information is generated based on the model indication information and the prompt information by using the large language model; a first resource is selected from among resources based on the interest description information and information about the resources, wherein a similarity score between the first resource and the interest description information is greater than that of a second resource.

### CROSS-REFERENCE TO RELATED APPLICATIONS

This application is a continuation application of International Application No. PCT/CN2024/115110 filed on Aug. 28, 2024, which claims priority to Chinese Patent Application No. 202311220326.0 filed with the China National Intellectual Property Administration on Sep. 21, 2023, the disclosures of each being incorporated by reference herein in their entireties.

### FIELD

Embodiments of this application relate to the field of computer technologies, and to a resource screening method and apparatus, a computer device, and a storage medium.

### BACKGROUND

With the development of internet technologies, resources on the internet are increasingly abundant and diverse. To enable a user to perform an interaction behavior on a resource of interest to the user, the resource of interest to the user may be recommended to the user.

### SUMMARY

According to an aspect of the disclosure, a resource screening method performed by a computer device, includes obtaining historical behavior information of an object and model indication information, the historical behavior information indicating that the object has interacted with a resource, the model indication information indicating that a large language model generates interest description information based on input information, and the interest description information describing a resource of interest to the object; generating prompt information based on the historical behavior information, the prompt information indicating a resource with which the object has interacted; generating the interest description information based on the model indication information and the prompt information by using the large language model; and selecting, based on the interest description information and information about a plurality of resources, a first resource from among the plurality of resources, a similarity score between the information about the first resource and the interest description information being greater than a similarity score between the information about a second resource and the interest description information, the second resource being another resource in the plurality of resources.

According to an aspect of the disclosure, a resource screening apparatus includes at least one memory configured to store computer program code; and at least one processor configured to read the computer program code and operate as instructed by the computer program code, the computer program code including obtaining code configured to cause at least one of the at least one processor to obtain historical behavior information of an object and model indication information, the historical behavior information indicating that the object has interacted with a resource, the model indication information indicating that a large language model generates interest description information based on input information, and the interest description information describing a resource of interest to the object; generating code configured to cause at least one of the at least one processor to generate prompt information based on the historical behavior information, the prompt information indicating a resource with which the object has interacted, and to generate the interest description information based on the model indication information and the prompt information by using the large language model; and screening code configured to cause at least one of the at least one processor to select, based on the interest description information and information about a plurality of resources, a first resource from among the plurality of resources, a similarity score between the information about the first resource and the interest description information being greater than a similarity score between the information about a second resource and the interest description information, the second resource being another resource in the plurality of resources.

According to an aspect of the disclosure, a non-transitory computer-readable storage medium, storing computer code which, when executed by at least one processor, causes the at least one processor to at least obtain historical behavior information of an object and model indication information, the historical behavior information indicating that the object has interacted with a resource, the model indication information indicating that a large language model generates interest description information based on input information, and the interest description information describing a resource of interest to the object; generate prompt information based on the historical behavior information, the prompt information indicating a resource with which the object has interacted, and to generate the interest description information based on the model indication information and the prompt information by using the large language model; and select, based on the interest description information and information about a plurality of resources, a first resource from among the plurality of resources, a similarity score between the information about the first resource and the interest description information being greater than a similarity score between the information about a second resource and the interest description information, the second resource being another resource in the plurality of resources.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of a structure of some embodiments according to some embodiments.

FIG. 2 is a flowchart of a resource screening method according to some embodiments.

FIG. 3 is a flowchart of another resource screening method according to some embodiments.

FIG. 4 is a schematic diagram of a structure of a resource screening apparatus according to some embodiments.

FIG. 5 is a schematic diagram of a structure of another resource screening apparatus according to some embodiments.

FIG. 6 is a schematic diagram of a structure of a terminal according to some embodiments.

FIG. 7 is a schematic diagram of a structure of a server according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

Terms such as “first”, “second”, “third”, and “fourth” as used in some embodiments are provided for describing various concepts in the disclosure. Unless otherwise specified, the concepts are not limited by the terms. The terms are configured for distinguishing one concept from another concept. For example, without departing from the scope of this application, a first resource may be referred to as a second resource, and similarly, the second resource may be referred to as the first resource.

The terms “module [s]” or “unit [s]” may refer to hardware logic, a processor or processors executing computer software code, or a combination of both. The “modules” or “units” may also be implemented in software stored in a memory of a computer or a non-transitory computer-readable medium, where the instructions of each unit are executable by a processor to thereby cause the processor to perform the respective operations of the corresponding module or unit.

Each module or unit may exist respectively or be combined into one or more units. Some modules or units may be further split into multiple smaller function subunits, thereby implementing the same operations without affecting the technical effects of some embodiments. The modules or units are divided based on logical functions. In actual applications, a function of one module or unit may be realized by multiple modules or units, or functions of multiple modules or units may be realized by one module or unit. In some embodiments, the apparatus may further include other modules or units. In actual applications, these functions may also be realized cooperatively by the other modules or units, and may be realized cooperatively by multiple modules or units.

Information (including but not limited to user equipment information, user personal information, and the like), data (including but not limited to data for analysis, data for storage, data for display, and the like), and signals in some embodiments are all authorized by users or fully authorized by all parties, and collection, use, and processing of relevant data should comply with relevant laws, regulations, and standards of relevant countries and regions. For example, historical behavior information of an object and model indication information in some embodiments are obtained under full authorization.

In some embodiments, before a resource is recommended to a user, a resource of interest to the user may be selected. Accuracy of a resource screening method is poor. Embodiments of this application provide a resource screening method, which can improve accuracy of the selected resource. According to the solutions provided in embodiments of this application, a large language model can be trained based on machine learning technologies of artificial intelligence, to implement the resource screening method by using a trained large language model.

The resource screening method provided in embodiments of this application can be performed by a computer device. In some embodiments, the computer device is a terminal or a server. In some embodiments, the server is an independent physical server, a server cluster including a plurality of physical servers or a distributed system, or a cloud server that provides cloud computing services such as a cloud service, a cloud database, cloud computing, a cloud function, cloud storage, a network service, cloud communication, a middleware service, a domain name service, a security service, a content delivery network (CDN), and a big data and artificial intelligence platform. In some embodiments, the terminal is, but is not limited to, a smartphone, a tablet, a notebook computer, a desktop computer, a smart speaker, a smartwatch, an intelligent voice interaction device, a smart household appliance, a vehicle-mounted terminal, and the like.

In some embodiments, a computer program in embodiments of this application may be deployed on a computer device for execution, or may be executed on a plurality of computer devices at one location, or may be executed on a plurality of computer devices distributed at a plurality of locations and connected via a communication network. The plurality of computer devices distributed at the plurality of locations and connected via the communication network can form a blockchain system.

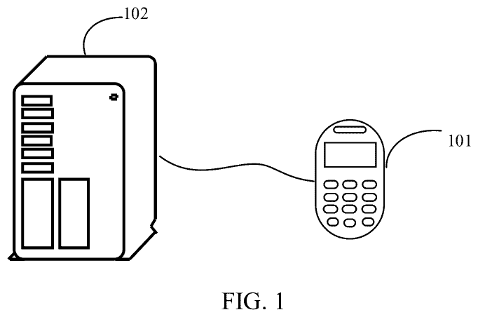

In some embodiments, the computer device is provided as a server. FIG. 1 is a schematic diagram of some embodiments according to some embodiments. Refer to FIG. 1. Some embodiments may include a terminal 101 and a server 102. The terminal 101 and the server 102 are connected to each other via a wired or wireless network. The terminal 101 is configured to display a resource. The server 102 is configured to provide a resource recommendation service, and can recommend a resource to the terminal 101 by using a large language model, so that an object to which the terminal 101 belongs can view the recommended resource.

In some embodiments, an application whose service is provided by the server 102 is installed on the terminal 101, and the terminal 101 can implement functions such as resource viewing and resource sharing by using the application. In some embodiments, the application is an application in an operating system of the terminal 101, or an application provided by a third party. For example, the application is a content sharing application, and the content sharing application has a content sharing function. The content sharing application can further have other functions, such as a review function, a shopping function, a navigation function, and a game function.

The terminal 101 is configured to log in to the application based on an object identifier, and view a resource in the application by using the application. The server 102 is configured to recommend, to the terminal 101 by using the large language model, a resource of interest to the object that is indicated by the object identifier, and the terminal 101 displays the recommended resource for the object to view.

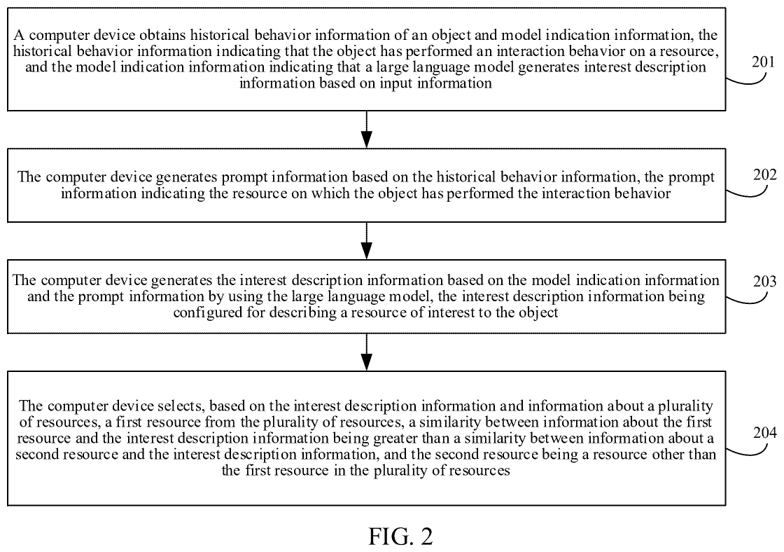

FIG. 2 is a flowchart of a resource screening method according to some embodiments. The method is performed by a computer device. As shown in FIG. 2, the method includes the following operations.

201: The computer device obtains historical behavior information of an object and model indication information, the historical behavior information indicating that the object has performed an interaction behavior on a resource, the model indication information indicating that a large language model generates interest description information based on input information, the interest description information being information that describes an interest of the object, and the interest description information being configured for describing a resource of interest to the object.

In some embodiments, because the historical behavior information of the object indicates the resource on which the object has performed the interaction behavior, the interest of the object can be reflected. By using a generalization capability and an inference capability of the large language model, a natural language description configured for describing a preference of the object can be generated with reference to the historical behavior information, to use the natural language description as an interest representation of the object, and the resource of interest to the object can be selected with reference to information about the resource.

The large language model (LLM) includes abundant knowledge information, and has the generalization capability and the inference capability. For example, the large language model is an open-source large model, for example, a large language model Meta AI (LLaMA, which is an open-source large model) or a chat general language model (ChatGLM). Based on the input information by using the large language model, a piece of information related to the input information can be generated. For example, input information of the large language model is as follows: “generating a description about scenery recommendation.” A piece of text information about the scenery recommendation is generated based on the input information by using the large language model. The object is any object. For example, the object is a user. The historical behavior information indicates a resource on which the object has performed an interaction behavior. The interaction behavior indicated by the historical behavior information can be any type of behavior. For example, the interaction behavior indicated by the historical behavior information may be a positive behavior, for example, clicking, giving a thumb-up, adding to favorites, or sharing. The resource is any resource. For example, the resource is an item link, a multimedia resource, or another resource.

The model indication information is equivalent to task indication information of the large language model, to indicate the large language model to execute a task, indicate the large language model to execute processing based on the input information, to generate a piece of information. For example, the model indication information is as follows: “You are a personalized recommendation system. I will tell you an item list previously clicked by a user, and you mine interests and preferences of the user from previous historical behaviors of the user, and write a piece of language to describe the user preferences.” The historical behavior information, the model indication information, and the interest description information can all be represented in any form. For example, the historical behavior information, the model indication information, and the interest description information are all represented in a text form. The model indication information indicates the large language model to generate a piece of text information for describing the interest of the object.

202: The computer device generates prompt information based on the historical behavior information, the prompt information indicating the resource on which the object has performed the interaction behavior.

In some embodiments, the historical behavior information indicates the resource on which the object has performed the interaction behavior. Based on the historical behavior information of the object, resources on which the object has performed interaction behaviors during a historical period can be obtained, and a piece of prompt information can then be generated to indicate those resources.

For example, the prompt information is as follows: “The following are commodities that the object has recently clicked: badminton rackets, sports pants, and outdoor sunscreen.”

203: The computer device generates the interest description information based on the model indication information and the prompt information by using the large language model.

In some embodiments, the large language model has the generalization capability and the inference capability. By using the large language model and in a processing manner indicated by the model indication information, the resource of interest to the object is obtained through inference with reference to the resource on which the object has performed the interaction behavior and that is in the prompt information, to obtain the interest description information.

The interest description information can be information in any form. For example, the interest description information is text information represented in a natural language description. For example, the interest description information is as follows: “Based on the commodities recently clicked by the object, a shopping interest and preference of the object may be commodities related to sports, outdoor activities, personal care, and body protection, such as fitness equipment, sportswear, outdoor equipment, sunscreen, skin care products, protective gloves, knee pads, and elbow pads. The object may also be interested in other sports events and sports equipment, such as basketball, football, and tennis.”

204: The computer device selects, based on the interest description information and information about a plurality of resources, a first resource from the plurality of resources, a similarity between information about the first resource and the interest description information being greater than a similarity between information about a second resource and the interest description information, and the second resource being a resource other than the first resource in the plurality of resources.

In some embodiments, the interest description information is configured for describing the resource of interest to the object, and can represent interests and hobbies of the object, and the information about the resource is configured for representing the resource. In comparison of the interest description information and the information about the resource, a similarity between the interest description information and information about each of the resources can be determined. The similarity can reflect whether the object is interested in the resource, to select the first resource with the greater similarity from the plurality of resources, select the resource of interest to the object, to ensure accuracy of the selected resource.

The information about the resource can be information in any form. For example, the information about the resource is text information or another type of information. For example, the information about the resource includes a title and a category of the resource, and introduction information of the resource.

In some embodiments, because the historical behavior information of the object indicates the resource on which the object has performed the interaction behavior, the interest of the object can be reflected. The large language model has the generalization capability and the inference capability. The large language model is indicated to generate, based on the model indication information with reference to the historical behavior information, the natural language description for describing the preference of the object, to use the natural language description as the interest representation of the object, and the resource of interest to the object is selected with reference to the information about the resource, so that a large language model-based resource screening manner is implemented, to ensure matching of the selected resource with the interest of the object, thereby ensuring accuracy of the selected resource.

According to some embodiments shown in FIG. 2, in some embodiments, the prompt information can be generated with reference to a plurality of pieces of historical behavior information. The first resource is selected in a similarity computation manner, and the first resource is recommended to the object. For a process, refer to the following embodiment.

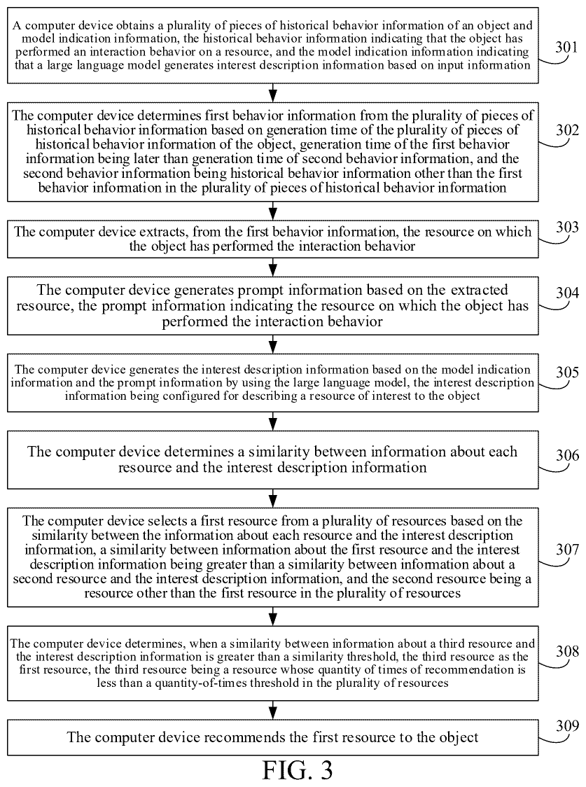

FIG. 3 is a flowchart of another resource screening method according to some embodiments. The method is performed by a computer device. As shown in FIG. 3, the method includes the following operations.

301: The computer device obtains a plurality of pieces of historical behavior information of an object and model indication information, the historical behavior information indicating that the object has performed an interaction behavior on a resource, the model indication information indicating that a large language model generates interest description information based on input information, and the interest description information being configured for describing a resource of interest to the object.

In some embodiments, generation time of different historical behavior information is different. The generation time is equivalent to time when the object performs an interaction behavior on a resource.

In some embodiments, the historical behavior information includes an object identifier, a resource identifier, and the generation time. The object identifier indicates the object that performs the interaction behavior.

The resource identifier indicates the resource on which the object has performed the interaction behavior. The resource identifier is a unique identifier for representing a resource, and has uniqueness and stability. The resource identifier is represented by a number or a character string. The indicated resource can be determined based on the resource identifier, or a resource library can be queried for the resource indicated by the resource identifier. In some embodiments, the historical behavior information further includes an operation identifier. The operation identifier indicates the interaction behavior performed by the object on the resource.

In some embodiments, the model indication information further indicates a type of the input information.

In some embodiments, the type of the input information can reflect input information. The type of the input information is indicated in the model indication information, so that the large language model can process the input information in a processing manner matching the type indicated by the model indication information, to generate information for describing an interest of the object, thereby ensuring accuracy of subsequently generated information.

In some embodiments, the obtained model indication information matches a recommendation field.

The recommendation field is a category of the resource, and resources in different recommendation fields are different. For example, the recommendation field includes a movie field, a music field, a book field, a news field, and the like.

In some embodiments, the large language model is applicable to a plurality of recommendation fields, and each of the recommendation fields corresponds to a type of model indication information. In any of the recommendation fields, model indication information matching the recommendation field is obtained, to ensure that the large language model can subsequently output information related to the recommendation field. The applicability of the large language model to a plurality of recommendation scenarios can be ensured by deploying one large language model for each of the recommendation fields, thereby improving applicability and reducing deployment costs.

In some embodiments, a manner of obtaining the model indication information includes: obtaining, in response to a resource recommendation instruction, model indication information matching a current recommendation field.

The resource recommendation instruction indicates recommending a resource to the object. The resource recommendation instruction is actively triggered by the object or is triggered in response to a resource-obtaining instruction from the object.

302: The computer device determines first behavior information from the plurality of pieces of historical behavior information based on their respective generation times, the generation time of the first behavior information being later than the generation time of second behavior information, the second behavior information being historical behavior information other than the first behavior information in the plurality of pieces of historical behavior information.

In some embodiments, the historical behavior information has a generation time, which is equivalent to the time when the object performs an interaction behavior on a resource. A later generation time indicates that the corresponding historical behavior information is more capable of reflecting an interest and a preference of the object. Historical behavior information with a later generation time is selected from the plurality of pieces of historical behavior information of the object, so that an interest description of the object can subsequently be determined based on the historical behavior information with the later generation time.

In some embodiments, operation 302 includes: determining, based on the generation times of the plurality of pieces of historical behavior information of the object, a first quantity of pieces of first behavior information; or determining, as the first behavior information, the historical behavior information for which an interval between its generation time and the current time is less than a target duration.

The first quantity may be any quantity, and the target duration may be any duration.

303: The computer device extracts, from the first behavior information, the resource on which the object has performed the interaction behavior.

In some embodiments, each piece of historical behavior information records a resource on which the object has performed an interaction behavior. When the first behavior information is determined from the plurality of pieces of historical behavior information, the resource on which the object has performed the interaction behavior can be extracted from each of the pieces of first behavior information. The extracted resource is the resource on which the object has performed the interaction behavior and that is extracted from the first behavior information.

In some embodiments, the historical behavior information further includes the operation identifier. Operation 303 includes: if a plurality of pieces of first behavior information are determined, screening, from the plurality of pieces of first behavior information based on an operation identifier included in the first behavior information, first behavior information including a target operation identifier; and extracting, from the first behavior information including the target operation identifier, the resource on which the object has performed the interaction behavior.

The target operation identifier indicates a positive interaction behavior. The positive interaction behavior is an interaction behavior that has positive effects on the resource. For example, the positive interaction behavior includes interaction behaviors such as clicking, giving a thumb-up, adding to favorites, and sharing.

304: The computer device generates prompt information based on the extracted resource, the prompt information indicating the resource on which the object has performed the interaction behavior.

In some embodiments, when resources on which the object has performed interaction behaviors in a historical period have been extracted, the resources are aggregated into prompt information, to indicate the resources on which the object has performed the interaction behavior in the historical period. In some embodiments, because the historical behavior information of the object is sparse, the prompt information is constructed by using the historical behavior information of the object, so that the large language model can subsequently generate the interest description information based on the prompt information. In some embodiments, a later generation time of historical behavior information indicates that the historical behavior information is more capable of reflecting the interest of the object. Based on the generation time of the historical behavior information, the prompt information is generated by using the historical behavior information with the later generation time to ensure that the prompt information can reflect a resource on which the object has recently performed an interaction behavior, thereby ensuring accuracy of the prompt information, so that a recent change of the interest of the object can be considered when the large language model subsequently generates the interest description information based on the prompt information, to ensure accuracy of the generated interest description information.

In some embodiments, operation 304 includes: obtaining a prompt information template, the prompt information template including a resource-filling location and relationship description information, the relationship description information being configured to describe a relationship between a resource at the resource-filling location and the object (which may include an interaction behavior between the object and the resource); and adding the extracted resource to the resource-filling location to obtain the prompt information.

In some embodiments, the prompt information template is configured for generating the prompt information. To facilitate generation of the prompt information, the prompt information template is preset, and the prompt information can be generated by filling the resource in the resource-filling location included in the prompt information template, to ensure convenience of generating the prompt information. This ensures that the generated prompt information can be understood by the large language model and improves the accuracy of the prompt information.

For example, the relationship description information is as follows: “The following are commodities that the user has recently clicked” or “the following are commodities that the user has recently purchased.”

In some embodiments, the prompt information template includes a first information template or a second information template. The first information template includes a resource-filling location and first relationship description information, and the first relationship description information is configured for describing a relationship between a resource at the resource-filling location and the object. The second information template includes a first filling location, a second filling location, first relationship description information, and second relationship description information. The first filling location is configured for filling the resource on which the object has performed the interaction behavior. The second filling location is configured for filling a resource on which the object most recently performed an interaction behavior. The first relationship description information is configured for describing a relationship between the resource at the first filling location and the object. The second relationship description information is configured for describing a relationship between the resource at the second filling location and the object.

The resource on which the object most recently performed the interaction behavior is the resource recorded in the historical behavior information that, among the plurality of pieces of historical behavior information of the object, has the generation time closest to the current time.

In some embodiments, a process of generating the prompt information includes: adding, when the prompt information template is the first information template, the extracted resource to the resource-filling location to obtain the prompt information; or, when the prompt information template is the second information template, adding the extracted resource to the first filling location and adding a resource from among the extracted resources on which the object most recently performed the interaction behavior to the second filling location, to obtain the prompt information.

In some embodiments, the prompt information generated based on the first information template reflects only the resource on which the object has performed the interaction behavior in the historical period. The prompt information generated based on the second information template not only reflects the resource on which the object has performed the interaction behavior in the historical period, but also highlights the resource on which the object has recently performed the interaction behavior, so that the recent change of the interest of the object can be considered when the large language model subsequently generates the interest description information based on the prompt information, to ensure accuracy of the generated interest description information.

For example, when the prompt information template is the first information template, the first relationship description information is as follows: “The following are commodities that the user has recently clicked.” The generated prompt information is as follows: “The following are the commodities that the user has recently clicked: badminton rackets, sports pants, and outdoor sunscreen.”

For example, when the prompt information template is the second information template, the first relationship description information is as follows: “The following are commodities that the user has recently clicked”, and the second relationship description information is as follows: “A commodity clicked by the user at the latest moment is.” The generated prompt information is as follows: “The following are the commodities that the user has recently clicked: badminton rackets, sports pants, and outdoor sunscreen, and the commodity clicked by the user at the latest moment is the outdoor sunscreen.”

In some embodiments, the prompt information is generated based on the first behavior information selected from the plurality of pieces of historical behavior information; in other embodiments, operations 302 through 304 are performed, and the prompt information is generated in another manner based on the historical behavior information.

305: The computer device generates the interest description information based on the model indication information and the prompt information by using the large language model, the interest description information being configured for describing the resource of interest to the object.

In some embodiments, the interest description information is configured for describing a resource type of interest to the object and a resource of interest to the object in the resource type; or the interest description information is configured for describing a resource on which the object is likely to perform an interaction behavior next time and a type to which the resource belongs.

The resource type can be any resource type. For example, the resource type is a sports type, an outdoor type, or a sports equipment type.

In some embodiments, because there are a plurality of types of resources in the resource type, the interest description information not only describes a resource type of interest to the object, but also describes a resource of interest to the object in the resource type, to ensure accuracy of the interest description information. When the interest description information describes the resource on which the object is likely to perform the interaction behavior next time and the type to which the resource belongs, this reflects that a resource on which the object is likely to perform an operation later is obtained through prediction based on the historical behavior information of the object, to reflect a resource of interest to the object later, thereby ensuring accuracy of the interest description information.

In some embodiments, the model indication information further indicates a format of the interest description information; and operation 305 includes: generating, based on the model indication information and the prompt information by using the large language model, the interest description information that belongs to the format.

In some embodiments, the model indication information indicates the format of the generated interest description information, so that the interest description information that belongs to the format is generated by using the large language model, to ensure that the generated interest description information can accurately describe the interest of the object, thereby ensuring accuracy of the interest description information.

For example, the model indication information indicates that the interest description information is text information and specifies a word count. The interest description information generated by using the large language model is text information that conforms to the specified word count.

In some embodiments, the prompt information is generated based on the first information template or the second information template. When the prompt information is generated based on the first information template or the second information template, the generated interest description information is different. In some embodiments, when the prompt information is generated based on the first information template, in the interest description information obtained through inference by the large language model, interests of the object are not distinguished, and the interest description information focuses on stable and long-term interests of the object. When the prompt information is generated based on the second information template, in the interest description information obtained through inference by the large language model, short-term interests and preferences of the object are more significantly focused on, and stable and long-term interests of the object can also be considered.

For example, when the prompt information is generated based on the first information template, the interest description information obtained through inference by the large language model is as follows: “Based on the commodities that the user has recently clicked, a shopping interest and preference of the user at a next moment may be predicted to be commodities related to sports, outdoor activities, personal care, and body protection, such as fitness equipment, sportswear, outdoor equipment, sunscreen, skin care products, protective gloves, knee pads, and elbow pads. The user may also be interested in other sports events and sports equipment, such as basketball, football, and tennis.”

For example, when the prompt information is generated based on the second information template, the interest description information obtained through inference by the large language model is as follows: “Based on previous behaviors of the user, the user is interested in sports and outdoor activities, and also cares about personal care and body protection. Based on a case in which the commodity clicked by the user at the latest moment is the outdoor sunscreen, it can be inferred that a shopping interest of the user at a next moment may extend to the field of personal care and body protection. The user may be interested in other commodities related to personal care and body protection, such as skin care products, sunscreen spray, sunscreen hats, and sunscreen clothes. The user may also be interested in other sports events and sports equipment, such as other sports equipment, sports shoes, and sports accessories because the user previously clicked badminton rackets and sports accessories.”

Based on the interest description information in the foregoing two examples, the interest description information includes terms of commodity names such as “fitness equipment, sportswear, outdoor equipment, sunscreen, skin care products, protective gloves, knee pads, elbow pads, basketball, football, and tennis,” and terms of commodity categories such as “sports, outdoor activities, and personal care.” The interest description information generated based on the large language model can represent the preferences of the object, and the interest description information already includes abundant interest features of the object and information that is related to potential resources. The interest description information can represent the interest of the object.

In some embodiments, operation 305 includes: performing feature extraction on the model indication information and the prompt information by using the large language model, to obtain a feature of the model indication information and a feature of the prompt information; and generating the interest description information based on the feature of the model indication information and the feature of the prompt information.

In some embodiments, the large language model separately extracts the feature of the model indication information and the feature of the prompt information in a feature extraction manner, so that accurate interest description information is generated by using the feature of the model indication information and the feature of the prompt information.

In some embodiments, a process of generating the interest description information includes: splicing the feature of the model indication information and the feature of the prompt information; and generating the interest description information based on a feature obtained through splicing.

In some embodiments, the feature of the model indication information and the feature of the prompt information are spliced, to ensure that the feature of the model indication information and the feature of the prompt information can be fully integrated, so that, based on the feature obtained through splicing, the large language model can learn how to perform processing with reference to the prompt information to generate the interest description information, thereby ensuring accuracy of the interest description information.

306: The computer device determines a similarity between information about each of the resources and the interest description information.

In some embodiments, the similarity between the information about the resource and the interest description information indicates that the resource has a higher correlation with the object, and can also reflect a degree to which the object is interested in the resource. A greater similarity indicates that the object is more interested in the resource, while a smaller similarity indicates that the object is less interested in the resource.

In some embodiments, operation 306 includes: separately performing feature extraction on the information about each of the resources and the interest description information by using the large language model, to obtain a feature of each of the resources and an interest feature; and determining the similarity between the information about each of the resources and the interest description information based on the feature of each of the resources and the interest feature.

In some embodiments, because the large language model includes abundant knowledge information and has a generalization capability and an inference capability, that quality of extracted features can be ensured by using the large language model to extract the feature of the information about the resource and the feature of the interest description information, to ensure accuracy of the extracted features, thereby ensuring accuracy of the determined similarity.

The interest feature is the feature corresponding to the interest description information. The similarity between the information about the resource and the interest description information is determined based on the feature, and this can be determined by using a cosine similarity or in another manner.

For example, the information about each of the resources is encoded by using the large language model to obtain a feature of each of the resources, and the feature is represented by a semantic representation vector. The feature of each of the resources is represented as a vector eᵢ and a vector eᵢ∈R^{1×d}. R is configured for representing feature space, i is configured for representing a sequence number of the resource, and d is configured for representing a dimension of the vector eᵢ. The feature of each of the resources is a 1×d vector.

In some embodiments, a manner of determining the similarity based on the feature of each of the resources and the interest feature satisfies the following relationship:

$${r}_{i} = {p}_{f} {e}_{i}^{T}$$

$${e}_{i}^{T}$$

represents transposition of a semantic representation vector eᵢ of an i^{th} resource, P_{f} is configured for representing an interest feature and may be a semantic representation vector, and rᵢ is configured for representing a similarity between information about the i^{th} resource and the interest description information.

In some embodiments, the feature of the resource is obtained in a process of determining the similarity between the information about the resource and the interest description information, while in some embodiments, before operation 301, the feature of each of the resources can also be obtained by performing feature extraction on the information about each of the resources by using the large language model.

In some embodiments, when the feature of each of the resources is obtained, features of the plurality of resources are stored in a feature library. In some embodiments, the features of the plurality of resources are generated in advance, and the features of the plurality of resources are stored in the feature library, so that when the resource is subsequently recommended to the object, the resource of interest to the object can be selected from the plurality of resources by using the features of the resources in the feature library and with reference to the interest description information, to recommend the resource of interest to the object.

The feature library is a database in any form. For example, the feature library is Faiss (an open-source and high-performance similarity search library). Faiss has functions of large-scale vector retrieval and clustering, is configured to resolve a problem of similarity search for a high-dimensional vector, and can be used in various fields, for example, used in the fields of images, audio, and texts.

In some embodiments, the feature of the resource and the resource identifier are correspondingly stored in the feature library. In some embodiments, the feature of the resource and the resource identifier are correspondingly stored in the feature library, an index between the feature of the resource and the resource identifier is established, and subsequently, a resource represented by the feature of each of the resources can be determined based on the index in the feature library.

In some embodiments, when the features of the plurality of resources are stored in the feature library, the features of the plurality of resources are extracted from the feature library, and the similarity between the information about each of the resources and the interest description information is determined with reference to the interest feature, so that the resources can be subsequently screened based on similarities.

307: The computer device selects a first resource from the plurality of resources based on the similarity between the information about each of the resources and the interest description information, a similarity between information about the first resource and the interest description information being greater than a similarity between information about a second resource and the interest description information, and the second resource being a resource other than the first resource in the plurality of resources.

In some embodiments, based on the similarity between the information about each of the resources and the interest description information, a resource with a sufficiently great similarity can be selected from the plurality of resources as the first resource, and the first resource is equivalent to the resource of interest to the object.

In some embodiments, operation 307 includes: sorting the plurality of resources based on the similarity between the information about each of the resources and the interest description information; and selecting the first n resources from the sorted plurality as the first resources.

n is a positive integer, and the plurality of resources is in descending order of the similarities. In some embodiments, sorting is performed in descending order of the similarities so that any selected first resource has a similarity greater than that of any unselected resource, thereby ensuring that the selected first resource is the resource of interest to the object and improving the accuracy of selection.

308: The computer device determines, when a similarity between information about a third resource and the interest description information is greater than a similarity threshold, the third resource as the first resource, the third resource being a resource whose recommendation count is less than a quantity-of-times threshold in the plurality of resources.

In some embodiments, a resource whose recommendation count is less than the quantity-of-times threshold in the plurality of resources is treated as a new resource. The third resource is a new resource in the plurality of resources. When the similarity between information about the new resource and the interest description information is sufficiently great, this indicates that the new resource satisfies a selection condition and that the user is likely interested in the new resource. The similarity threshold can be any value and is set by a developer in a recommendation system. In some embodiments, when the similarity between the information about the new resource and the interest description information is sufficiently great, the new resource is used as the resource of interest to the object to implement a cold start for the new resource, thereby enabling accurate recommendation of the new resource and improving recommendation accuracy.

In some embodiments, only the resource whose recommendation count is less than the quantity-of-times threshold is selected in the foregoing manner. If the recommendation count of a resource reaches the quantity-of-times threshold, the resource is selected according to operation 307 and is no longer selected according to operation 308.

In some embodiments, only a second quantity of resources is selected from the plurality of resources at a time. A screening process includes: when the similarity between the information about the third resource and the interest description information is greater than the similarity threshold, determining the third resource as the first resource; determining a third quantity, the third quantity being a number of currently determined first resources; determining a difference between the second quantity and the third quantity; and selecting, from the remaining resources, a number of first resources equal to the difference based on the similarity between the information about each of the resources and the interest description information according to operation 307.

The second quantity may be any quantity, and the third quantity may be any quantity.

In some embodiments, when only a quantity (for example, the second quantity) of resources is selected at a time, if any new resource satisfies the selection condition, the new resources that satisfy the selection condition are selected as the (for example, third-quantity) first resources, and resources with the greatest similarities are selected from the remaining resources as first resources based on the magnitudes of the similarities, so that a first quantity (the difference between the second quantity and the third quantity) of first resources is selected. This not only ensures that the number of selected first resources equals the first quantity and that the selected first resources are resources of interest to the object, but also ensures inclusion of the new resource, thereby enabling a cold start of the new resource when the first resource is subsequently recommended to the object.

309: The computer device recommends the first resource to the object.

In some embodiments, the selected first resources are all resources of interest to the object. The first resource is recommended to the object, to ensure accuracy of resource recommendation.

In some embodiments, the similarity between the information about the first resource that is recommended to the object and the interest description information is sufficiently great. This ensures that the resource recommended to the object conforms to the interest of the object. For a new resource, according to the method provided in some embodiments, the new resource can be used as the resource of interest to the object when the similarity between the information about the new resource and the interest description information is sufficiently great, thereby accurately recommending the new resource and avoiding the problem that accurate recommendation cannot be performed due to a lack of sufficient historical data and user feedback. In this way, a cold start of the new resource is implemented, improving recommendation accuracy.

In some embodiments, because the historical behavior information of the object indicates the resource on which the object has performed the interaction behavior, the interest of the object can be reflected. The large language model has generalization and inference capabilities. The large language model is directed, based on the model indication information and with reference to the historical behavior information, to generate a natural-language description of the object's preference, to use that natural-language description as an interest representation of the object, and to select the resource of interest to the object with reference to information about the resource, thereby implementing a large language model-based resource screening manner. The screening manner is applicable to a plurality of scenarios, to ensure matching of the selected resource with the interest of the object, thereby ensuring accuracy of the selected resource.

The similarity between the information about the first resource that is recommended to the object and the interest description information is sufficiently great, which ensures that the resource recommended to the object conforms to the interest of the object, thereby improving recommendation accuracy. For a new resource, according to the method provided in some embodiments, the new resource is accurately recommended, avoiding the problem that accurate recommendation cannot be performed due to a lack of sufficient historical data and user feedback, so that a cold start of the new resource is implemented and recommendation accuracy is improved.

The solution provided in some embodiments is applicable to a plurality of small- and medium-scale scenarios. Because there is little historical behavior data of the object in such scenarios, a recommendation model for those scenarios cannot be obtained through training by using the historical behavior data of the object. The large language model includes abundant knowledge information and has generalization and inference capabilities. A recommendation system with universality is built based on the large language model. By using the generalization capability of the large language model on small datasets and its abundant semantic knowledge information, dependency on interaction information of behavior sequences is reduced, so that a resource cold start with few resources and sparse historical behavior data of the object in small- and medium-scale scenarios can be implemented, thereby effectively improving accuracy of resource recommendation in a cold-start scenario.

According to some embodiments shown in FIG. 3, the feature of each of the resources is obtained in advance by using the large language model, and the features of the plurality of resources and corresponding resource identifiers are stored in the feature library in advance, to establish the index between the feature of the resource and the resource identifier in advance. If a new resource is added to the recommendation system, according to operation 306, feature extraction is performed on the information about the new resource based on the large language model to obtain a feature of the new resource, and the feature of the new resource and a resource identifier of the new resource are correspondingly stored in the feature library to update the index. When the resource is recommended to the object, the interest description information is first generated according to operations 301 through 305. According to operation 306, feature extraction is performed on the interest description information based on the large language model to obtain the interest feature. According to operation 307, similarities between the features of the resources in the feature library and the interest feature are determined, features of the first n resources with the greatest similarities are selected, resource identifiers corresponding to the selected features are determined based on the index in the feature library, and resources indicated by the selected resource identifiers are determined as the first resources. For the new resource, the first resource is selected from the new resource according to operation 308, and the first resource is recommended to the object according to operation 309, to implement the cold start of the new resource. If the recommendation count of a new resource reaches the quantity-of-times threshold, the new resource is selected according to operation 307 and is no longer selected according to operation 308.

In some embodiments shown in FIG. 3, the first resource is selected from the plurality of resources by using the similarity threshold; in other embodiments, operations 306 through 308 are performed, and the first resource is selected from the plurality of resources in another manner based on the interest description information and the information about the plurality of resources. In some embodiments, a process of selecting the first resource includes the following operation 1 to operation 3.

Operation 1: Determine a similarity between information about each of the resources and the interest description information.

Operation 2: Amplify, based on an amplification coefficient, a similarity corresponding to a third resource, the third resource being a resource whose recommendation count is less than a quantity-of-times threshold in the plurality of resources.

The amplification coefficient is configured for amplifying the similarity of the third resource, and the amplification coefficient may be any coefficient. For example, the amplification coefficient is a value greater than 1. The similarity corresponding to the third resource is a similarity between information about the third resource and the interest description information.

In some embodiments, a process of amplifying the similarity corresponding to the third resource includes: using a product of the similarity corresponding to the third resource and the amplification coefficient as an amplified similarity of the third resource.

Operation 3: Select the first resource from the plurality of resources based on the amplified similarity of the third resource and a similarity corresponding to a fourth resource, the fourth resource being a resource other than the third resource in the plurality of resources, a similarity between information about the first resource and the interest description information being greater than a similarity between information about a second resource and the interest description information, and the second resource being a resource other than the first resource in the plurality of resources.

In some embodiments, when the similarity between the information about each of the resources and the interest description information is determined, a similarity corresponding to the new resource is amplified. Based on the magnitudes of the similarities, the resource of interest to the object is then selected from the plurality of resources using the amplified similarity of the new resource and a similarity corresponding to another resource, so that a cold-start manner of the resource is implemented. Because resource recommendation is performed based on a degree of user interest, amplifying the similarity of the new resource preferentially ensures that the selected resource is a resource of interest to the object while the cold start of the resource is implemented, thereby ensuring accuracy of subsequent recommendation.

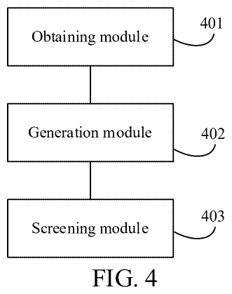

FIG. 4 is a schematic diagram of a structure of a resource screening apparatus according to some embodiments. As shown in FIG. 4, the apparatus includes:
an obtaining module 401, configured to: obtain historical behavior information of an object and model indication information, the historical behavior information indicating that the object has performed an interaction behavior on a resource, the model indication information indicating that a large language model generates interest description information based on input information, and the interest description information being configured for describing a resource of interest to the object;
a generation module 402, configured to generate prompt information based on the historical behavior information, the prompt information indicating the resource on which the object has performed the interaction behavior, and
the generation module 402 being further configured to generate the interest description information based on the model indication information and the prompt information by using the large language model; and
a screening module 403, configured to select, based on the interest description information and information about a plurality of resources, a first resource from the plurality of resources, a similarity between information about the first resource and the interest description information being greater than a similarity between information about a second resource and the interest description information, and the second resource being a resource other than the first resource in the plurality of resources.

In some embodiments, the screening module 403 is configured to: determine a similarity between information about each of the resources and the interest description information; amplify, based on an amplification coefficient, a similarity corresponding to a third resource, the third resource being a resource whose recommendation count is less than a quantity-of-times threshold in the plurality of resources; and select the first resource from the plurality of resources based on an amplified similarity of the third resource and a similarity corresponding to a fourth resource, the fourth resource being a resource other than the third resource in the plurality of resources.

In some embodiments, the screening module 403 is configured to: separately perform feature extraction on the information about each of the resources and the interest description information by using the large language model, to obtain a feature of each of the resources and an interest feature; and determine the similarity between the information about each of the resources and the interest description information based on the feature of each of the resources and the interest feature.

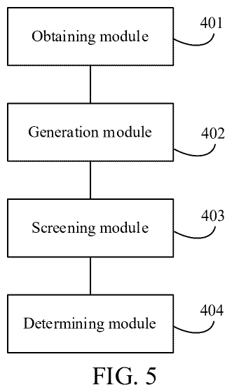

In some embodiments, as shown in FIG. 5, the apparatus further includes:
a determining module 404, configured to determine the third resource as the first resource when a similarity between information about the third resource and the interest description information is greater than a similarity threshold, the third resource being the resource whose recommendation count is less than the quantity-of-times threshold in the plurality of resources.

In some embodiments, the model indication information further indicates a format of the interest description information; and the generation module 402 is configured to generate, based on the model indication information and the prompt information by using the large language model, the interest description information that belongs to the format.

In some embodiments, the generation module 402 is configured to: determine, based on generation time of a plurality of pieces of historical behavior information of the object, first behavior information from the plurality of pieces of historical behavior information, generation time of the first behavior information being later than generation time of second behavior information, and the second behavior information being historical behavior information other than the first behavior information in the plurality of pieces of historical behavior information; extract, from the first behavior information, the resource on which the object has performed the interaction behavior; and generate the prompt information based on the extracted resource.

In some embodiments, the generation module 402 is configured to: obtain a prompt information template, the prompt information template including a resource filling location and relationship description information, and the relationship description information being configured for describing a relationship between a resource at the resource filling location and the object; and add the extracted resource to the resource filling location, to obtain the prompt information.

In some embodiments, the interest description information is configured for describing a resource type of interest to the object and a resource of interest to the object in the resource type; or the interest description information is configured for describing a resource on which the object is likely to perform an interaction behavior next time and a type to which the resource belongs.

The resource screening apparatus provided in some embodiments is described only by using an example of division of the foregoing functional modules. In an actual application, the foregoing functions may be allocated to and completed by different functional modules based on requirements. For example, an internal structure of the computer device is divided into different functional modules to complete all or some of the functions described above. The resource screening apparatus and resource screening method embodiments provided in some embodiments belong to the same concept. For an implementation process of the resource screening apparatus, refer to some embodiments.

Some embodiments further provide a computer device. The computer device includes a processor and a memory. The memory has at least one computer program stored therein, and the at least one computer program is loaded and executed by the processor, to implement an operation performed in the resource screening method in some embodiments.

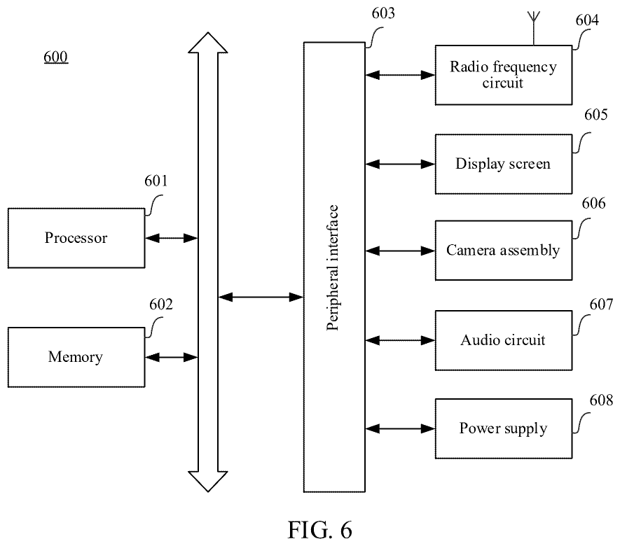

In some embodiments, the computer device is provided as a terminal. FIG. 6 is a block diagram of a structure of a terminal 600 according to some embodiments. The terminal 600 includes a processor 601 and a memory 602.

The processor 601 may include one or more processing cores, such as a 4-core processor and an 8-core processor. The processor 601 may be implemented in at least one hardware form of a digital signal processor (DSP), a field-programmable gate array (FPGA), or a programmable logic array (PLA). The processor 601 may include a main processor and a coprocessor. The main processor is a processor configured to process data in an awake state, and is also referred to as a central processing unit (CPU). The coprocessor is a low power consumption processor configured to process data in a standby state. In some embodiments, the processor 601 may be integrated with a graphics processing unit (GPU). The GPU is configured to render and draw content that may be displayed on a display screen. In some embodiments, the processor 601 may further include an artificial intelligence (AI) processor. The AI processor is configured to process a computing operation related to machine learning.

The memory 602 may include one or more computer-readable storage media. The computer-readable storage medium may be non-transient. The memory 602 may further include a high-speed random access memory and a non-volatile memory, for example, one or more disk storage devices or flash storage devices. In some embodiments, the non-transient computer-readable storage medium in the memory 602 is configured to store at least one computer program. The at least one computer program is configured to be executed by the processor 601, to implement the resource screening method provided in some embodiments.

In some embodiments, the terminal 600 may include, for example, a peripheral interface 603 and at least one peripheral. The processor 601, the memory 602, and the peripheral interface 603 may be connected through a bus or a signal cable. Each peripheral may be connected to the peripheral interface 603 through a bus, a signal cable, or a circuit board. The peripheral includes at least one of a radio frequency circuit 604, a display screen 605, a camera assembly 606, an audio circuit 607, and a power supply 608.

A person skilled in the art may understand that, the structure shown in FIG. 6 constitutes no limitation on the terminal 600, and the terminal may include more or fewer components than those shown in the figure, or some components may be combined, or a different component deployment may be used.

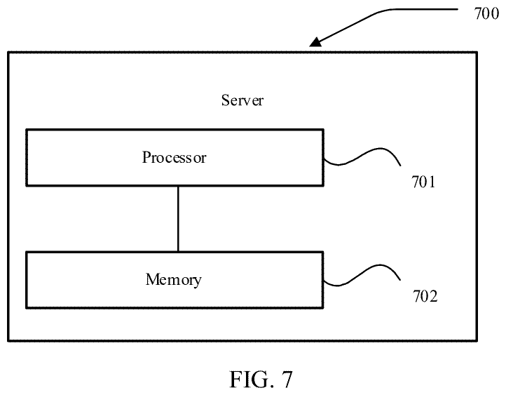

In some embodiments, the computer device is provided as a server. FIG. 7 is a schematic diagram of a structure of a server according to some embodiments. The server 700 may vary greatly due to different configurations or performance, and may include one or more processors (central processing units, CPU) 701 and one or more memories 702. The memory 702 has at least one computer program stored therein, and the at least one computer program is loaded and executed by the processor 701, to implement the method provided in some embodiments. The server may further include components such as a wired or wireless network interface, a keyboard, and an input/output interface for input and output. The server may further include another component configured to implement a device function. Details are not described herein.

Some embodiments further provide a computer-readable storage medium. The computer-readable storage medium has at least one computer program stored therein, and the at least one computer program is loaded and executed by a processor, to implement an operation performed in the resource screening method in some embodiments.

Some embodiments further provide a computer program product, including a computer program. When the computer program is executed by a processor, an operation performed in the resource screening method in some embodiments is implemented.

A person of ordinary skill in the art may understand that all or some of operations for implementing some embodiments may be completed by hardware, or may be completed by a program instructing relevant hardware. The program may be stored in a computer-readable storage medium. The storage medium mentioned above may be a read-only memory, a magnetic disk, an optical disc, or the like.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A resource screening method performed by a computer device, the method comprising:
obtaining historical behavior information of an object and model indication information, the historical behavior information indicating that the object has interacted with a resource, the model indication information indicating that a large language model generates interest description information based on input information, and the interest description information describing a resource of interest to the object;
generating prompt information based on the historical behavior information, the prompt information indicating a resource with which the object has interacted;
generating the interest description information based on the model indication information and the prompt information by using the large language model; and
selecting, based on the interest description information and information about a plurality of resources, a first resource from among the plurality of resources, a similarity score between the information about the first resource and the interest description information being greater than a similarity score between the information about a second resource and the interest description information, the second resource being another resource in the plurality of resources.

2. The method of claim 1, wherein the selecting the first resource from among the plurality of resources comprises:
determining similarity scores between the information about the plurality of resources and the interest description information;
amplifying, based on an amplification coefficient, a similarity score corresponding to a third resource, the third resource being a resource whose recommendation count is less than a quantity-of-times threshold; and
selecting the first resource from among the plurality of resources based on the amplified similarity score and a similarity score corresponding to a fourth resource from among the plurality of resources.

3. The method of claim 1, wherein the determining similarity scores between the information about the plurality of resources and the interest description information comprises:
performing feature extraction on the information about the plurality of resources and the interest description information by using the large language model to obtain a plurality of resource features and an interest feature; and
determining the similarity scores between the information about the plurality of resources and the interest description information based on the plurality of resource features and the interest feature.

4. The method according to claim 1, wherein the method further comprises:
determining the third resource as the first resource based on a similarity score between the information about the third resource and the interest description information being greater than a similarity score threshold, wherein the third resource has a recommendation count that is less than the quantity-of-times threshold in the plurality of resources.

5. The method of claim 1, wherein the model indication information further comprises information indicating a format of the interest description information, and wherein the generating the interest description information comprises:
generating, based on the model indication information and the prompt information by using the large language model, the interest description information in the indicated format.

6. The method of claim 1, wherein the generating the prompt information based on the historical behavior information comprises:
selecting, based on generation times of multiple pieces of historical behavior information of the object, first behavior information from among the multiple pieces of historical behavior information, wherein the generation time of the first behavior information is later than a generation time of second behavior information other than the historical behavior information;
extracting, from the first behavior information, the resource with which the object has interacted; and
generating the prompt information based on the extracted resource.

7. The method of claim 1, wherein the generating the prompt information comprises:
obtaining a prompt information template comprising a resource entry location and relationship description information describing a relationship between a resource at the resource entry location and the object; and
adding the extracted resource to the resource entry location to obtain the prompt information.

8. The method of claim 1, wherein the interest description information describes a resource type of interest to the object and a resource of interest within that resource type.

9. The method of claim 1, wherein the interest description information describes a resource with which the object is likely to interact next and a type to which that resource belongs.

10. The method of claim 1, wherein the first resource is selected from a cold start and the interest description information is generated as a natural language description.

11. A resource screening apparatus comprising:
at least one memory configured to store computer program code; and
at least one processor configured to read the computer program code and operate as instructed by the computer program code, the computer program code comprising:
obtaining code configured to cause at least one of the at least one processor to obtain historical behavior information of an object and model indication information, the historical behavior information indicating that the object has interacted with a resource, the model indication information indicating that a large language model generates interest description information based on input information, and the interest description information describing a resource of interest to the object;
generating code configured to cause at least one of the at least one processor to generate prompt information based on the historical behavior information, the prompt information indicating a resource with which the object has interacted, and to generate the interest description information based on the model indication information and the prompt information by using the large language model; and
screening code configured to cause at least one of the at least one processor to select, based on the interest description information and information about a plurality of resources, a first resource from among the plurality of resources, a similarity score between the information about the first resource and the interest description information being greater than a similarity score between the information about a second resource and the interest description information, the second resource being another resource in the plurality of resources.

12. The apparatus of claim 11, wherein the screening code is configured to cause at least one of the at least one processor to:
determine similarity scores between the information about the plurality of resources and the interest description information;
amplify, based on an amplification coefficient, a similarity score corresponding to a third resource, the third resource being a resource whose recommendation count is less than a quantity-of-times threshold; and
select the first resource from among the plurality of resources based on the amplified similarity score and a similarity score corresponding to a fourth resource from among the plurality of resources.

13. The apparatus of claim 11, wherein the screening code is configured to cause at least one of the at least one processor to:
perform feature extraction on the information about the plurality of resources and the interest description information by using the large language model to obtain a plurality of resource features and an interest feature; and
determine the similarity scores between the information about the plurality of resources and the interest description information based on the plurality of resource features and the interest feature.

14. The apparatus of claim 11, wherein the screening code is configured to cause at least one of the at least one processor to:
determine the third resource as the first resource based on a similarity score between the information about the third resource and the interest description information being greater than a similarity score threshold, wherein the third resource has a recommendation count that is less than the quantity-of-times threshold in the plurality of resources.

15. The apparatus of claim 11, wherein the model indication information further comprises information indicating a format of the interest description information, and wherein the generating code is configured to cause at least one of the at least one processor to:
generate, based on the model indication information and the prompt information by using the large language model, the interest description information in the indicated format.

16. The apparatus of claim 11, wherein the generating code is configured to cause at least one of the at least one processor to:
select, based on generation times of multiple pieces of historical behavior information of the object, first behavior information from among the multiple pieces of historical behavior information, wherein the generation time of the first behavior information is later than a generation time of second behavior information other than the historical behavior information;
extract, from the first behavior information, the resource with which the object has interacted; and
generate the prompt information based on the extracted resource.

17. The apparatus of claim 11, wherein the generating code is configured to cause at least one of the at least one processor to:
obtain a prompt information template comprising a resource entry location and relationship description information describing a relationship between a resource at the resource entry location and the object; and
add the extracted resource to the resource entry location to obtain the prompt information.

18. The apparatus of claim 11, wherein the generating code is configured to cause at least one of the at least one processor to generate the interest description information describing a resource type of interest to the object and a resource of interest within that resource type.

19. The apparatus of claim 11, wherein the generating code is configured to cause at least one of the at least one processor to generate the interest description information describing a resource with which the object is likely to interact next and a type to which that resource belongs.

20. A non-transitory computer-readable storage medium, storing computer code which, when executed by at least one processor, causes the at least one processor to at least:
obtain historical behavior information of an object and model indication information, the historical behavior information indicating that the object has interacted with a resource, the model indication information indicating that a large language model generates interest description information based on input information, and the interest description information describing a resource of interest to the object;
generate prompt information based on the historical behavior information, the prompt information indicating a resource with which the object has interacted, and to generate the interest description information based on the model indication information and the prompt information by using the large language model; and
select, based on the interest description information and information about a plurality of resources, a first resource from among the plurality of resources, a similarity score between the information about the first resource and the interest description information being greater than a similarity score between the information about a second resource and the interest description information, the second resource being another resource in the plurality of resources.
